(19) United States
(12) Patent Application Publication
(10) Pub. No.: US 2017/0109737 A1
(43) Pub. Date: Apr. 20, 2017

(54) METHOD FOR SUPPORTING PAYMENT SERVICE USING INTEGRATED CODE, AND SYSTEM AND APPARATUS THEREFOR

(71) Applicant: SK Planet Co., Ltd., Seongnam-si (KR)

(72) Inventor: Sebyung KWAK, Seoul (KR)

(21) Appl. No.: 15/392,931

(22) Filed: Dec. 28, 2016

Related U.S. Application Data
(63) Continuation of application No. PCT/KR2015/008850, filed on Aug. 25, 2015.

(30) Foreign Application Priority Data
Oct. 13, 2014 (KR) 10-2014-0137581
Oct. 20, 2014 (KR) 10-2014-0141927

(51) Int. Cl. G06Q 20/38; G06Q 20/20

(52) U.S. Cl. CPC G06Q 20/383; G06Q 20/202

(57) ABSTRACT

The present invention relates to a payment service which, in particular, generates an integrated code by randomizing user information and additional information associated with the purchase of a plurality of products, and performs payment by applying the integrated code. Accordingly, when a customer purchases a plurality of products at a certain store, payment for the products can be conducted simultaneously using the integrated code and thus is convenient. Further, it is possible to enhance security by providing user information and the additional information after randomization thereof, and it is also possible to pay online for an item which has been purchased offline, thereby providing high payment compatibility. In addition, a one-click payment service using an integrated code for a plurality of products is possible.

### TECHNICAL FIELD

The present invention relates to a payment service, and more particularly, to a method for supporting a payment service using an integrated code in which an integrated code is generated for purchasing a product by randomizing user information and additional information, and a payment service for a terminal having requested the generation or a payment service through sharing between terminals may be supported using the generated integrated code, and a system and apparatus for the method.

### BACKGROUND ART

With the development of mobile communication networks and specifications of terminals, a mobile communication terminal has deviated from a conventional category of a simple communication device or an information providing device and become an essential belonging of a contemporary person, and there is a developing trend toward a total entertainment device. In particular, due to such continuous development, a mobile communication terminal which is considered to be a necessity for a contemporary person has not only achieved miniaturization and weight reduction, but is also being reformed as a complex communication terminal having various functions.

Such a mobile communication terminal can provide a payment service using a barcode. Currently, a barcode, which is attached to each product and allows recognition of product information, is read by a barcode scanner provided at a cash register or a point of sales (POS) system of a large store and is usefully used to automatically organize sales data. Since a code system has extended from a one-dimensional arrangement to a two or more-dimensional arrangement and containable information is rapidly increasing, the range of use is expanding day by day.

However, when a customer purchases a plurality of products at a particular store, there is an inconvenience in performing a payment operation several times to make payments for the respective products, and a system for managing franchisee information, the amount of payments, and information on a payment means in an integrated manner is necessary.

Also, there is a barcode, a quick response (QR) code, etc. for each product. Therefore, when an offline payment is made with a portable terminal, it is necessary to perform a payment operation several times to make payments for a plurality of products, and the payment operations for the plurality of products cannot be performed in an integrated manner. In the case of a product without a barcode, a QR code, and the like or a device which has difficulty in recognizing a barcode, a QR code, and the like, payment is impossible and identity verification is difficult. Also, expandability to additional functions is low.

### DISCLOSURE

### Technical Problem

To avoid an inconvenience in performing a payment operation several times and making payments for a plurality of products when a customer purchases the plurality of products at a particular store, the present invention is directed to providing a method for supporting a payment service using an integrated code in which an integrated code is generated by randomizing user information and additional information to purchase a plurality of products, and a payment can be made using the integrated code, and a system and apparatus for the method.

Further, the present invention is directed to providing a method for supporting a payment service using an integrated code in which a terminal capable of generating an integrated code transmits the integrated code to a terminal not capable of generating an integrated code so that the terminal not capable of generating an integrated code can also use the integrated code, and a system and apparatus for the method.

### Technical Solution

One aspect of the present invention provides a service apparatus including: a service communication unit configured to communicate with a plurality of terminals and transmit and receive data for providing a payment service based on an integrated code; and a service control unit configured to collect user information and additional information for processing a payment related to a product purchase from any one terminal, randomize the collected user information and additional information, generate an integrated code based on the randomized user information and additional information, and provide the generated integrated code to the terminal.

The user information may include at least one of an identity (ID), a name, and a social security number for identifying a user.

The additional information may include franchisee information, payment information, and at least one piece of payment means information.

The service control unit may randomize the additional information by randomly setting the additional information to a combination of characters, numbers, or signs.

The service control unit may check a random code corresponding to the user information and a random code corresponding to the additional information and generate the integrated code by combining the checked random codes.

The service control unit may additionally collect authentication information from the terminal together with the user information and the additional information.

The authentication information may include information on at least one authentication means among a password, fingerprint recognition information, and biometric information.

When an integrated code identical to the integrated code provided to the terminal and authentication information are received from another terminal, the service control unit may perform control so that authentication is performed by comparing the authentication information received from the terminal and the authentication information received from the other terminal and then the payment service is provided according to a request of the other terminal.

Another aspect of the present invention provides a terminal including: a communication unit configured to communicate with a service apparatus and transmit and receive data for making a payment related to a product purchase based on an integrated code; and a control unit configured to acquire user information and additional information for the payment related to the product purchase, transmit the acquired user information and additional information to the service apparatus, receive an integrated code generated based on randomized user information and additional information from the service apparatus, and perform control so that the payment is made using the received integrated code.

The control unit may select information on at least one payment means among a credit card payment, a mobile payment, an account transfer, a cash payment, a debit card payment, a discount card, and a point card and perform control so that the selected information on a payment means is included in the additional information or transmitted to the service apparatus after the integrated code is received.

After the user information and the additional information for the payment related to the product purchase are collected, the control unit may randomize the collected user information and additional information, generate the integrated code based on the randomized user information and additional information, and perform control so that the payment is made using the generated integrated code.

The controller may additionally collect authentication information together with the user information and the additional information for the payment related to the product purchase, and share the generated integrated code with at least one other terminal.

When an integrated code and authentication information are received from the other terminal and the authentication information received from the other terminal and the collected authentication information match, the control unit may finish authentication and then perform control by requesting a payment service using the received integrated code from the service apparatus so that the payment is made.

Another aspect of the present invention provides a method for supporting a payment service using an integrated code, the method including: collecting, by a service apparatus, user information and additional information for a payment related to a product purchase from any one terminal; randomizing, by the service apparatus, the collected user information and additional information; generating, by the service apparatus, an integrated code based on the randomized user information and additional information; and providing, by the service apparatus, the generated integrated code to the terminal.

The method may further include, after the providing of the generated integrated code to the terminal: receiving, by the service apparatus, information on at least one payment means among a credit card payment, a mobile payment, an account transfer, a cash payment, a discount card, and a point card; combining, by the service apparatus, the received information on a payment means and the previously generated integrated code; and processing, by the service apparatus, the payment using the integrated code combined with the payment means.

The collecting of the user information and the additional information may include additionally collecting, by the service apparatus, authentication information from the terminal, and the method may further include, after the providing of the generated integrated code to the terminal: receiving, by the service apparatus, an integrated code identical to the integrated code provided to the terminal and authentication information from another terminal; comparing, by the service apparatus, the authentication information received from the terminal and the authentication information received from the other terminal to perform authentication; and processing, by the service apparatus, the payment according to a request of the other terminal when the authentication succeeds.

### Advantageous Effects

According to the present invention, when a customer purchases a plurality of products at a particular store, it is possible to simultaneously perform payments for the respective products using an integrated code, which is convenient.

Also, since user information and additional information are randomized and provided, security can be improved. Since a payment for a product purchased offline can be made online, payment compatibility is high.

Also, a one-click payment service using an integrated code for a plurality of products is possible.

Also, since a user performs personal authentication through a portable terminal, there is no worry about non-authentication.

Also, a customer can easily and conveniently make an integrated payment for several products by inputting only a payment amount and numbers or characters of a randomized code and the like.

Also, it is possible to avoid difficulties in recognizing a barcode, a quick response (QR) code, and the like.

### DESCRIPTION OF DRAWINGS

FIG. 1 is a diagram showing a system for supporting a payment service using an integrated code according to an exemplary embodiment of the present invention.

FIG. 2 is a block diagram showing a configuration of a terminal according to the present invention.

FIG. 3 is a block diagram showing a configuration of a service apparatus according to the present invention.

FIG. 4 is a flowchart illustrating a method for supporting a payment service using an integrated code in a terminal according to an exemplary embodiment of the present invention.

FIG. 5 is a flowchart illustrating a method for supporting a payment service using an integrated code in a service apparatus according to an exemplary embodiment of the present invention.

FIG. 6 is a flowchart illustrating a method for supporting a payment service using an integrated code in a terminal according to another exemplary embodiment of the present invention.

FIG. 7 is a flowchart illustrating a method for supporting a payment service using an integrated code in a service apparatus according to another exemplary embodiment of the present invention.

FIG. 8 is a flowchart illustrating a method for supporting a payment service using an integrated code according to still another exemplary embodiment of the present invention.

FIG. 9 is a flowchart illustrating a method for supporting a payment service using an integrated code according to still another exemplary embodiment of the present invention.

FIG. 10 is a flowchart illustrating an operating method of a terminal receiving an integrated code from another terminal and performing a payment service according to still another exemplary embodiment of the present invention.

### MODES OF THE INVENTION

Exemplary embodiments of the present invention will now be described in detail with reference to the accompanying drawings. However, detailed descriptions of well-known functions and configurations that may obscure the gist of the present invention will be omitted in the following description and the accompanying drawings. Further, it should be noted that like components are denoted by like reference symbols throughout the drawings whenever possible.

Terms or words used in the present specification and claims described below are not to be construed as common or dictionary meanings but are to be construed as meanings and concepts in accordance with the technical spirit of the present invention based on a principle that the inventor can define terms suitably for the best explanation of his or her own invention. Embodiments described in the present specification and configurations shown in the drawings are merely exemplary embodiments of the present invention and do not represent the whole technical spirit of the present invention. Therefore, it should be understood that there can be various equivalents and modifications at the filing date of the present invention.

Although a mobile communication terminal that is connected to a communication network and provides a payment service using an integrated code is described below as a representative example of a terminal according to an exemplary embodiment of the present invention, the terminal is not limited to the mobile communication terminal and may be various terminals, such as any information communication device, multimedia terminal, wired terminal, fixed terminal, Internet protocol (IP) terminal, and the like. Also, the terminal may be advantageously used when the terminal is a mobile terminal having various mobile communication specifications, such as a cellular phone, a portable multimedia player (PMP), a mobile Internet device (MID), a smart phone, a desktop computer, a tablet personal computer (PC), a notebook computer, a netbook, an information communication device, or the like.

Hereinafter, a system for supporting a payment service using an integrated code according to an exemplary embodiment of the present invention will be described.

FIG. 1 is a diagram showing a system for supporting a payment service using an integrated code according to an exemplary embodiment of the present invention.

Referring to FIG. 1, a system 100 for supporting a payment service using an integrated code according to the present invention includes a terminal 10, a service apparatus 20, and a communication network 30.

A processor installed in the terminal 10 or the service apparatus 20 may process a program instruction for performing the method according to the present invention. The processor may be a single-threaded processor according to an exemplary embodiment, and the processor may be a multi-threaded processor according to another exemplary embodiment. Further, the processor may process instructions stored in a memory or a storage device.

The communication network 30 performs a series of data transceiving operations for data transmission and information exchange between the terminals 10 and the service apparatus 20. In particular, various communication networks may be used as the communication network 30. For example, wireless communication networks including wireless local area network (WLAN), wireless fidelity (Wi-Fi), wireless broadband (WiBro), worldwide interoperability for microwave access (WiMAX), high speed downlink packet access (HSDPA), etc., or wired communication networks including Ethernet, digital subscriber line (xDSL) (asymmetric DSL (ADSL) and very high bit rate DSL (VDSL)), fiber to the curb (FTTC), fiber to the home (FTTH), etc. may be used. Meanwhile, the communication network 30 is not limited to the aforementioned communication schemes and may include any other communication scheme that is widely known or will be developed in the future.

The terminals 10 are connected to the service apparatus 20 through the communication network 30 and transmit and receive all data related to provision of a payment service using an integrated code. In particular, the terminal 10 according to exemplary embodiments of the present invention acquires user information and additional information for a payment related to a product purchase and transmits the acquired user information and additional information to the service apparatus 20. Here, the user information includes information, such as an identity (ID), a name, a social security number, etc. for directly or indirectly identifying a user, and the additional information includes franchisee information, payment information, and at least one piece of payment means information. Meanwhile, the user information may include any other information that may be a means of personal identification.

The terminal 10 receives an integrated code generated on the basis of randomized user information and additional information from the service apparatus 20 and makes the payment using the received integrated code. In other words, the terminal 10 may select information of a payment means, such as a credit card payment, a mobile payment, an account transfer, a cash payment, a debit card payment, a discount card, or a point card, and transmit the selected information on a payment means to the service apparatus 20, thereby supporting a payment service so that the service apparatus 20 may provide the payment service using the integrated code according to the payment means. Also, the terminal 10 according to the present invention may select a plurality of payment means so that various payment means may be used.

The terminal 10 according to another exemplary embodiment of the present invention may generate an integrated code by itself. In other words, the terminal 10 of the present invention collects user information and additional information to make a payment related to a product purchase, and randomizes the collected user information and additional information. Here, the terminal 10 randomizes the additional information by randomly setting the additional information to be a combination of a finite number of characters, numbers, or signs.

Then, the terminal 10 generates the integrated code on the basis of the randomized user information and the additional information. Here, the terminal 10 checks a random code corresponding to the user information and a random code corresponding to the additional information and generates the integrated code by sequentially combining the checked random codes. Subsequently, the terminal 10 makes the payment using the generated integrated code.

The terminal 10 according to still another exemplary embodiment of the present invention may share an integrated code received from the service apparatus 20 or an integrated code it generated itself with another terminal to process a payment. Here, the terminal 10 of the present invention acquires authentication information, transmits the authentication information to the service apparatus 20, and then receives an integrated code generated on the basis of randomized user information and additional information from the service apparatus 20. Also, after generating the integrated code, the terminal 10 may transmit the generated integrated code to the service apparatus 20 and share the generated integrated code by transmitting the generated integrated code to another terminal. At this time, the terminal 10 may transmit the authentication information through a text message or other means.

Meanwhile, the terminal 10 of the present invention performs authentication for customer recognition based on terminal information or personal information input by a user and financial information. When an authenticated customer tries to make a payment, the terminal 10 confirms a franchisee by a unique store number being input to a payment application (app) or the like or automatic recognition based on a check for store location information. Subsequently, the user manually inputs an amount of a payment or the terminal 10 automatically inputs a random number received from the service apparatus 20, and then the terminal 10 inputs a previously registered password to perform final authentication.

The service apparatus 20 is connected to the terminal 10 through the communication network 30 and transmits and receives all data related to provision of the payment service using an integrated code. In particular, the service apparatus 20 according to the present invention collects user information and additional information for a payment related to a product purchase from the terminal 10. Here, the user information includes information, such as an ID, a name, a social security number, etc. for directly or indirectly identifying a user, and the additional information includes franchisee information, payment information, and at least one piece of payment means information. Meanwhile, the user information may include any other information that may be a means of personal identification.

The service apparatus 20 randomizes the collected user information and additional information. At this time, the service apparatus 20 randomizes the additional information by randomly setting the additional information to be a combination of a finite number of characters, numbers, or signs.

The service apparatus 20 generates the integrated code on the basis of the randomized user information and additional information. Here, the service apparatus 20 checks a random code corresponding to the user information and a random code corresponding to the additional information and generates the integrated code by sequentially combining the checked random codes.

The service apparatus 20 provides the generated integrated code to the terminal 10. Subsequently, the service apparatus 20 receives information on a payment means, such as a credit card payment, a mobile payment, an account transfer, a cash payment, a discount card, a point card, and the like, from the terminal 10. At this time, the service apparatus 20 may receive information on a plurality of payment means so that various payment means may be used. The service apparatus 20 may combine the received information on a payment means and the previously generated integrated code and process the payment using the integrated code combined with the payment means.

Also, when a payment using the integrated code is requested by a terminal different from the terminal 10 which has requested the generation of the integrated code of the present invention, the service apparatus 20 checks authentication information matching the integrated code and provides the payment service.

In other words, the service apparatus 20 of the present invention is connected to a plurality of terminals 10 (10a, 10b, . . . , and 10n) through the communication network 30 and transmits and receives all data related to provision of a secure payment service using an integrated code. In particular, the service apparatus 20 according to the present invention collects user information, additional information, and authentication information from the terminal 10 for a payment related to a product purchase. Here, the authentication information includes information on at least one authentication means among a password, fingerprint recognition information, biometric information, etc. applied to a payment service using the integrated code. As described above, the service apparatus 20 randomizes the collected user information and additional information. At this time, the service apparatus 20 randomizes the additional information by randomly setting the additional information to be a combination of a finite number of characters, numbers, or signs. Meanwhile, the service apparatus 20 stores the authentication information collected from the terminal 10, and the stored authentication information is used to perform authentication by being compared with authentication information input from the terminal 10 or another terminal when a payment service using the integrated code is requested.

Subsequently, the service apparatus 20 generates an integrated code based on the randomized user information and additional information. Here, the service apparatus 20 checks a random code corresponding to the user information and a random code corresponding to the additional information and generates the integrated code by sequentially combining the checked random codes.

In this way, according to the present invention, when a customer purchases a plurality of products at a particular store, payments for the respective products are not separately performed and can be simultaneously performed using an integrated code, which is convenient. Also, since user information and additional information are randomized and provided, security can be improved. Since a payment for a product purchased offline can be made online, payment compatibility is high. Also, a one-click payment service using an integrated code for a plurality of products is possible. Also, since a user performs personal authentication through a portable terminal, there is no worry about non-authentication. Also, a customer can easily and conveniently make an integrated payment for several products by inputting only a payment amount and numbers or characters of a randomized code and the like. Also, it is possible to avoid difficulties in recognizing a barcode, a quick response (QR) code, and the like. Since a generated integrated code can be shared with another user and another user terminal can use the payment service through a simple authentication procedure, even a terminal incapable of generating an integrated code can use a payment service using an integrated code generated by another user.

Meanwhile, the terminal 10 and the service apparatus 20 in a configuration of the system 100 for supporting a payment service using an integrated code according to exemplary embodiments of the present invention may process a payment service by themselves to provide the payment service, and may operate in conjunction with an external point of sales (POS) device whose payment system has been built.

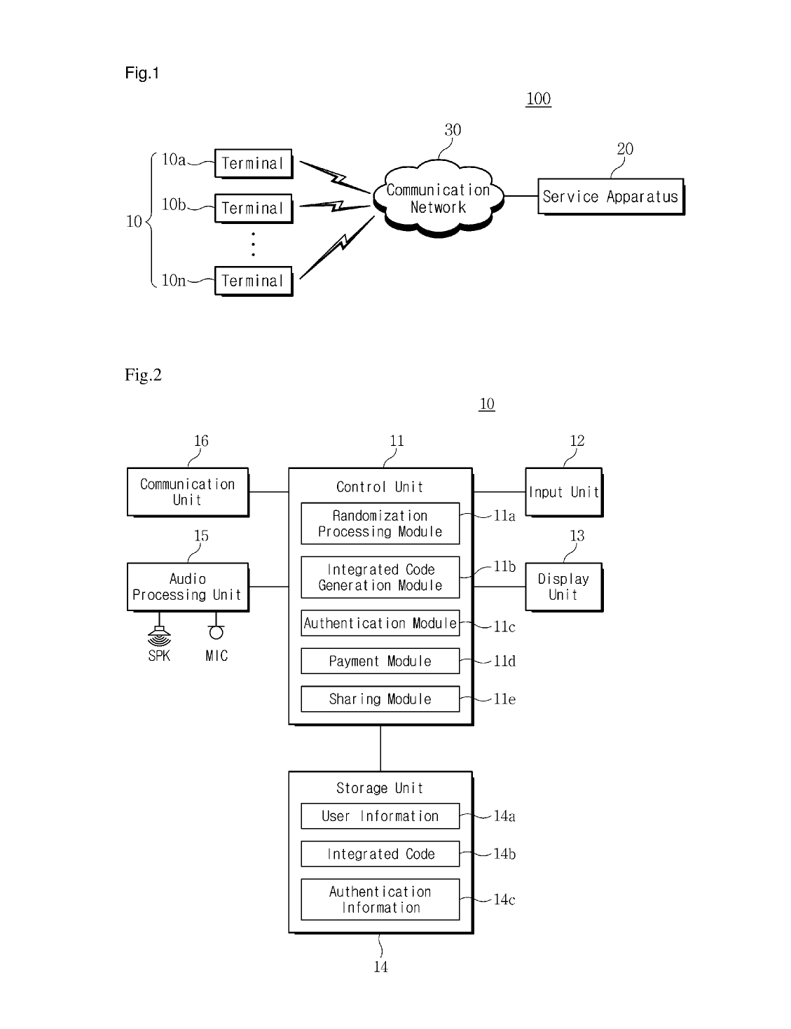

The above-described processes of providing the payment service using an integrated code according to exemplary embodiments of the present invention will be described in further detail with reference to FIGS. 2 to 10.

FIG. 2 is a block diagram showing a configuration of a terminal according to the present invention.

Referring to FIG. 2, the terminal 10 according to the present invention includes a control unit 11, an input unit 12, a display unit 13, a storage unit 14, an audio processing unit 15, and a communication unit 16. Here, the control unit 11 includes a randomization processing module 11a, an integrated code generation module 11b, an authentication module 11c, a payment module 11d, and a sharing module 11e, and the storage unit 14 includes user information 14a, an integrated code 14b, and authentication information 14c.

The input unit 12 receives various kinds of information, such as numerical information, text information, etc., and transfers signals, which are input in relation to settings of various functions and function control of the terminal 10, to the control unit 11. Also, the input unit 12 may include at least one of a keypad and a touchpad that generates an input signal according to a touch or manipulation of a user. Here, the input unit 12 may be integrally configured with the display unit 13 in the form of one touch panel (or touch screen) to simultaneously perform input and display functions. Also, the input unit 12 may be any kind of input means that will be developed in the future as well as an input device, such as a keyboard, a keypad, a mouse, a joystick, and the like. In particular, the input unit 12 according to the present invention senses a signal for selecting user information and additional information and transfers the signal to the control unit 11 to provide a payment service using an integrated code applied to a product purchase.

The display unit 13 displays information on a series of operating states, operation results, etc. of the terminal 10 performing a function. Also, the display unit 13 may display menus of the terminal 10, user data input by a user, and the like. Here, the display unit 13 may be configured as a liquid crystal display (LCD), a thin film transistor (TFT)-LCD, a light emitting diode (LED), an organic LED (OLED), an active matrix OLED (AMOLED), a retina display, a flexible display, a three-dimensional (3D) display, and the like. When the display unit 13 is configured in the form of a touch screen, the display unit 13 may perform some or all of functions of the input unit 12. In particular, the display unit 13 according to the present invention displays various screens required for a process of providing a payment service using an integrated code.

The storage unit 14, which is a device for storing data, includes a main memory unit and an auxiliary memory unit and stores application programs required for functional operation of the terminal 10. The storage unit 14 may roughly include a program region and a data region. Here, when the terminal 10 activates each function in response to a request of the user, the terminal 10 provides the function by executing a corresponding application program under control of the control unit 11. In particular, the storage unit 14 according to the present invention stores an operating system (OS) for booting the terminal 10, a program for randomizing user information and additional information into random codes, a program for generating an integrated code by combining random codes, a program for providing a payment service using an integrated code, and the like. Also, the storage unit 14 stores the user information 14a, the integrated code 14b, and the authentication information 14c. For example, the user information 14a includes information, such as an ID, a name, a social security number, etc. for directly or indirectly identifying a user. Also, user information and additional information are randomized, and the integrated code 14b is generated on the basis of the randomized user information and additional information and stored. Here, a random code is a combination of a finite number of characters, numbers, or signs to which corresponding additional information is randomly set. Also, the authentication information 14c includes information on at least one authentication means, such as a password, fingerprint recognition information, biometric information, etc., applied to a payment service using the integrated code.

The audio processing unit 15 performs a function of transferring an audio signal input from a speaker SPK or a microphone MIC for playing and outputting the audio signal to the control unit 11. The audio processing unit 15 may convert the analog audio signal input through the microphone into a digital audio signal and transfer the digital audio signal to the control unit 11. Also, the audio processing unit 15 may convert a digital audio signal output from the control unit 11 into an analog signal and output the analog signal through the speaker. In particular, the audio processing unit 15 according to the present invention outputs sound effects or execution sounds generated in the process of providing a payment service using an integrated code.

The communication unit 16 performs a function for transmitting and receiving data to and from the service apparatus 20 through the communication network 30. Here, the communication unit 16 includes a radio frequency (RF) transmitting means which up-converts a frequency of a signal to be transmitted and amplifies the signal, and an RF receiving means which low-noise amplifies a received signal and down-converts a frequency thereof. The communication unit 16 may include at least one of a wireless communication module (not shown) and a wired communication module (not shown). The wireless communication module is a component for transmitting and receiving data according to a wireless communication method, and when the terminal 10 uses wireless communication, it is possible to transmit and receive data to and from the service apparatus 20 using any one of a wireless network communication module, WLAN communication module, and a wireless personal area network (WPAN) communication module. The wired communication module is intended to transmit and receive data in a wired manner. The wired communication module may access the communication network 30 through a wire and transmit and receive data to and from the service apparatus 20. In particular, the communication unit 16 according to the present invention communicates with the service apparatus 20 and transmits and receives data related to the payment service provided on the basis of an integrated code.

The control unit 11 may be a process device that executes the OS and operates each component. In particular, the control unit 11 according to an exemplary embodiment of the present invention acquires user information and additional information for a payment related to a product purchase and transmits the acquired user information and additional information to the service apparatus 20. Also, the control unit 11 may acquire authentication information together with the user information and additional information and transmit the acquired user information, additional information, and authentication information to the service apparatus 20.

Here, the user information may include information, such as an ID, a name, a social security number, etc. for directly or indirectly identifying a user. The user information may include any other information that may be a means of personal identification. The additional information includes franchisee information, payment information, and payment means information. The authentication information includes information on at least one authentication means among a password, fingerprint recognition information, and biometric information applied to a payment service using an integrated code.

The control unit 11 receives an integrated code generated on the basis of randomized user information and additional information from the service apparatus 20 and makes a payment using the received integrated code. At this time, the control unit 11 may share the received integrated code with another terminal to make the payment. To this end, the control unit 11 may also share the authentication information with the terminal with which the integrated code is shared. In this case, the authentication information may be transmitted through a text message or other means when the integrated code is transmitted.

Meanwhile, the control unit 11 may select information on a payment means, such as a credit card payment, a mobile payment, an account transfer, a cash payment, a debit card payment, a discount card, a point card, and the like, and transmit the selected information on a payment means to the service apparatus 20. Here, the information on a payment means may be included in the additional information and transmitted, and conversely, the information on a payment means may be transmitted to the service apparatus 20 at a later time. The control unit 11 may select a plurality of payment means so that various payment means can be used.

The control unit 11 according to another exemplary embodiment of the present invention may receive an integrated code from the service apparatus 20 or generate an integrated code by itself. To this end, the control unit 11 of the present invention collects user information and additional information for a payment related to a product purchase and randomizes the collected user information and additional information. Here, the control unit 11 randomizes the additional information by randomly setting the additional information to be a combination of a finite number of characters, numbers, or signs.

Then, the control unit 11 generates an integrated code based on the randomized user information and additional information. Here, the control unit 11 checks a random code corresponding to the user information and a random code corresponding to the additional information and generates the integrated code by sequentially combining the checked random codes. Subsequently, the control unit 11 makes the payment using the generated integrated code.

Such an integrated code of the present invention will be described with examples. When a user (a) wants to purchase five products in a store (b), user information, franchisee information, and price information are randomized. When the randomized user information is 123a, the randomized franchisee information is 456b, and the randomized price information is 7890, an integrated code obtained by randomizing the user information, the franchisee information, and the price information may be, for example, 123a.456b.7890. Additionally, information on a payment means selected by the user may be included in the integrated code. Here, the payment means may be classified as a credit card payment (1), a mobile payment (2), an account transfer (3), a cash payment (4), a debit card payment (5), a discount card (6), a point card (7), and the like. When the information on a payment means selected by the user is the credit card payment (1), the integrated code is 123a.456b.7890.1, and the user may make a payment for the plurality of products online or offline using the integrated code. Meanwhile, random codes of the user information, the franchisee information, and the price information may be randomly generated as a combination of characters, numbers, signs, and the like.

In another example, when a user wants to purchase three products in a department store, user information, franchisee information, and price information are randomized. When the randomized user information is 123, randomized information on an affiliated store in the department store is 456, and randomized total price information of the three products is 20000, an integrated code obtained by randomizing the user information, the franchisee information, and the price information is 123.456.20000. Additionally, information on a payment means selected by the user and authentication information may be included in the integrated code. The payment means may be classified as a credit card payment (1), a mobile payment (2), an account transfer (3), a cash payment (4), a debit card payment (5), a discount card (6), a point card (7), and the like. When the information on a payment means selected by the user is the mobile payment (2) and the authentication information is 5225, the integrated code is 123.456.20000.2.5255, and the user may make a payment for the plurality of products online or offline using the integrated code. Meanwhile, random codes of the user information, the franchisee information, and the price information may be randomly generated as a combination of characters, numbers, signs, and the like.

In this way, when purchasing a plurality of products, payments for the respective products are not separately made and can be made in an integrated manner using an integrated code of the present invention.

In a method for supporting a payment service using an integrated code according to another exemplary embodiment of the present invention, the control unit 11 may perform authentication for customer recognition based on terminal information or personal information input by the user and financial information. When an authenticated customer tries to make a payment, the control unit 11 confirms a franchisee by a unique store number being input to a payment app or the like or automatic recognition based on a check for store location information. Subsequently, the user manually inputs an amount of a payment or the control unit 11 automatically inputs a random number received from the service apparatus 20, and then the control unit 11 inputs a previously registered password to perform final authentication.

Also, the control unit 11 may provide an integrated code received from the service apparatus 20 or an integrated code generated by the control unit 11 to another terminal or receive an integrated code from the other terminal. In this way, when the control unit 11 cannot generate the integrated code or the other terminal cannot generate the integrated code, the integrated code is shared so that a payment process for a plurality of products can be performed more easily.

To share the integrated code and further strengthen security when processing the payment, the control unit 11 may acquire and transmit authentication information to another terminal to which the integrated code will be transmitted. When the integrated code is received from the other terminal, the control unit 11 may receive authentication information from the other terminal. Then, the control unit 11 transmits the integrated code and the authentication information to the service apparatus 20 so that the service apparatus 20 may determine whether the integrated code and the authentication information match and provide the payment service.

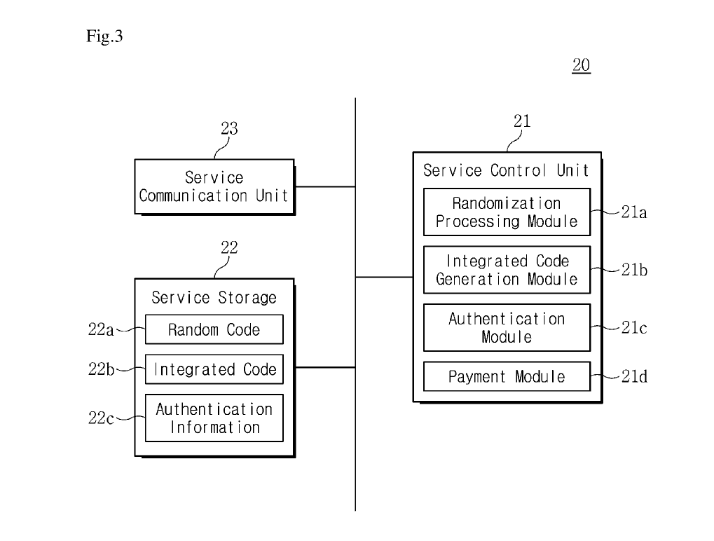

FIG. 3 is a block diagram showing a configuration of a service apparatus according to the present invention.

Referring to FIG. 3, the service apparatus 20 according to the present invention includes a service control unit 21, a service storage unit 22, and a service communication unit 23. Here, the service control unit 21 includes a randomization processing module 21a, an integrated code generation module 21b, an authentication module 21c, and a payment module 21d, and the service storage unit 22 includes random codes 22a, integrated codes 22b, and authentication information 22c.

The service communication unit 23 communicates with the terminal 10 through the communication network 30 and transmits and receives data for providing the payment service based on an integrated code.

The service storage unit 22 stores all programs in accordance with execution of functions of the service apparatus 20. In particular, the service storage unit 22 according to the present invention stores a program for randomizing user information and additional information received from the terminal 10 into random codes, a program for generating an integrated code by combining random codes, a program for providing a payment service using an integrated code, a program for performing authentication for a payment, and the like. Also, the service storage unit 22 stores a random code corresponding to the user information and a random code corresponding to the additional information. Also, the service storage unit 22 stores an integrated code generated by sequentially combining random codes. Here, a random code is a combination of a finite number of characters, numbers, or signs to which corresponding additional information is randomly set. Also, the service storage unit 22 stores information on at least one authentication means, such as a password, fingerprint recognition information, biometric information, etc., applied to a payment service using the integrated code.

The service control unit 21 may be a process device that executes an OS and operates each component. In particular, the service control unit 21 according to an exemplary embodiment of the present invention acquires user information and additional information for a payment related to a product purchase from the terminal 10. Here, the user information includes any information, such as an ID, a name, a social security number, etc. for directly or indirectly identifying a user. The additional information includes franchisee information, payment information, and payment means information. Also, the service control unit 21 may acquire authentication information from the terminal 10, and the authentication information includes information on at least one authentication means among a password, fingerprint recognition information, biometric information, etc. applied to a payment service using an integrated code.

The service control unit 21 randomizes the collected user information and additional information. At this time, the service control unit 21 randomizes the additional information by randomly setting the additional information to be a combination of a finite number of characters, numbers, or signs.

The service control unit 21 generates an integrated code on the basis of the randomized user information and additional information. Here, the service control unit 21 checks a random code corresponding to the user information and a random code corresponding to the additional information and generates the integrated code by sequentially combining the checked random codes.

Meanwhile, the service control unit 21 stores authentication information collected from the terminal 10, and the stored authentication information is used to perform authentication by being compared with authentication information input from the terminal 10 or another terminal when a payment service using the integrated code is requested.

The service control unit 21 provides the generated integrated code to the terminal 10. Meanwhile, the service control unit 21 may receive information on a payment means, such as a credit card payment, a mobile payment, an account transfer, a cash payment, a discount card, a point card, and on the like, from the terminal 10. Here, the information on a payment means may be included in the additional information and received, and otherwise, the information on a payment means may be separately received after the integrated code is transmitted to the terminal 10.

At this time, the service control unit 21 may receive information on a plurality of payment means so that various payment means can be used. The service control unit 21 may combine the received information on a payment means and the previously generated integrated code and process the payment using the integrated code combined with the payment means.

For example, when a user (A) wants to purchase five products in a store (B), the service control unit 21 randomizes user information, franchisee information, and price information. When the randomized user information is 123a, the randomized franchisee information is 456b, and the randomized price information is 7890, an integrated code obtained by randomizing the user information, the franchisee information, and the price information is 123a.456b.7890. Additionally, the service control unit 21 may include information on a payment means selected by the terminal 10 in the integrated code. Here, the payment means may be classified as a credit card payment (1), a mobile payment (2), an account transfer (3), a cash payment (4), a debit card payment (5), a discount card (6), a point card (7), and the like. When the information on a payment means selected by the terminal 10 is the credit card payment (1), the integrated code is 123a.456b.7890.1, and the terminal 10 may make a payment for the plurality of products online or offline using the integrated code. Meanwhile, random codes of the user information, the franchisee information, and the price information may be randomly generated as a combination of characters, numbers, signs, or so on.

The service apparatus 20 configured as described above may be implemented as one or more servers that operate in a server-based computing fashion or a cloud fashion. In particular, data for providing a payment service using an integrated code may be provided through a cloud computing function which may be permanently stored in a cloud computing device in the Internet. Here, cloud computing denotes a technology which serves digital terminals, such as a notebook, a netbook, etc., with information technology (IT) resources virtualized using Internet technology, for example, hardware (a server, a storage, a network, etc.), software (a database, security, a web server, etc.), a service, data, etc., on demand.

Meanwhile, a memory installed in the terminal 10 or the service apparatus 20 stores information therein. According to an exemplary embodiment, the memory is a computer-readable medium. The memory may be a volatile memory unit according to an exemplary embodiment, and the memory may be a non-volatile memory unit according to another exemplary embodiment. According to an exemplary embodiment, a storage device is a computer-readable medium. According to various different exemplary embodiments, the storage device may include, for example, a hard disk, an optical disk, or another mass storage device.

Although example configurations of apparatuses are described in the present specification and the drawings, implementations of functional operations and the subject matter described herein may be carried out using other types of digital electronic circuitry, in computer software, firmware, or hardware including the structures disclosed herein and their structural equivalents, or in a combination of one or more thereof. The subject matter described herein may be implemented as one or more computer program products, that is, one or more modules of computer program instructions, encoded on a tangible program storage medium to control the operation of or for execution by an apparatus according to the present invention. The computer-readable medium may be a machine-readable storage device, a machine-readable storage substrate, a memory device, a composition of matter affecting a machine-readable propagated signal, or a combination of one or more thereof.

Methods of supporting a payment service using an integrated code according to exemplary embodiments of the present invention will be described below.

The above present invention includes the following exemplary embodiments. The exemplary embodiments will be described focusing on a process of generating an integrated code by randomizing user information and additional information and then making a payment using the generated integrated code according to a request of a terminal which has requested the generation. Other exemplary embodiments will be described focusing on a process of performing a payment by sharing a generated integrated code between different terminals. While the exemplary embodiments may be implemented based on a configuration of a service apparatus for generating an integrated code, according to still another exemplary embodiment of the present invention, a terminal may generate an integrated code by itself.

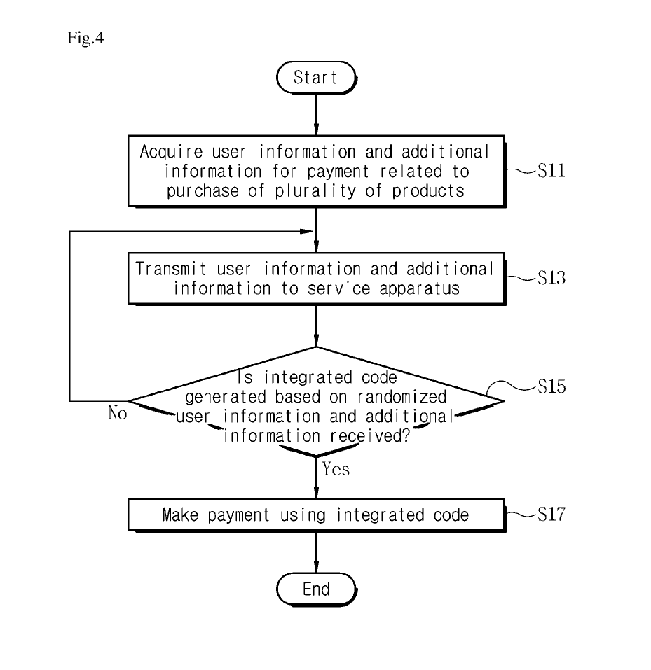

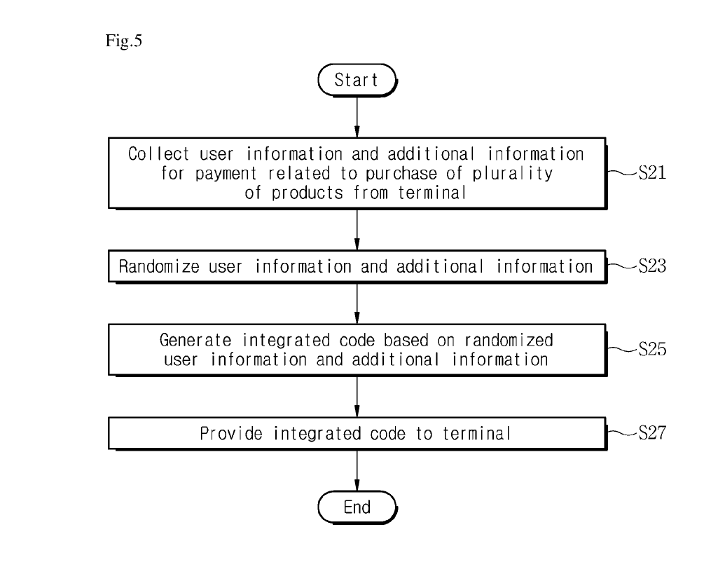

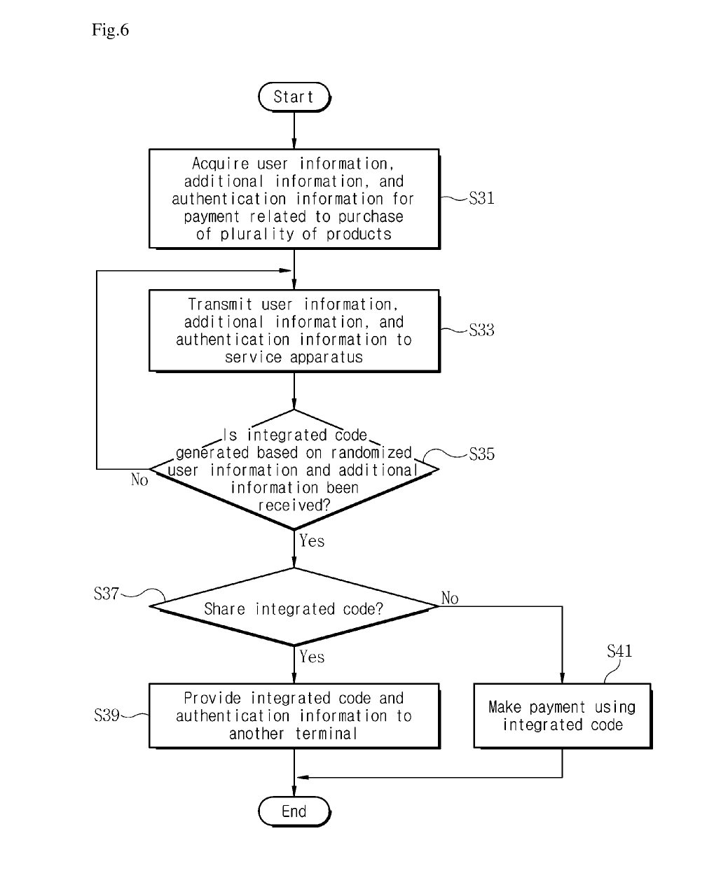

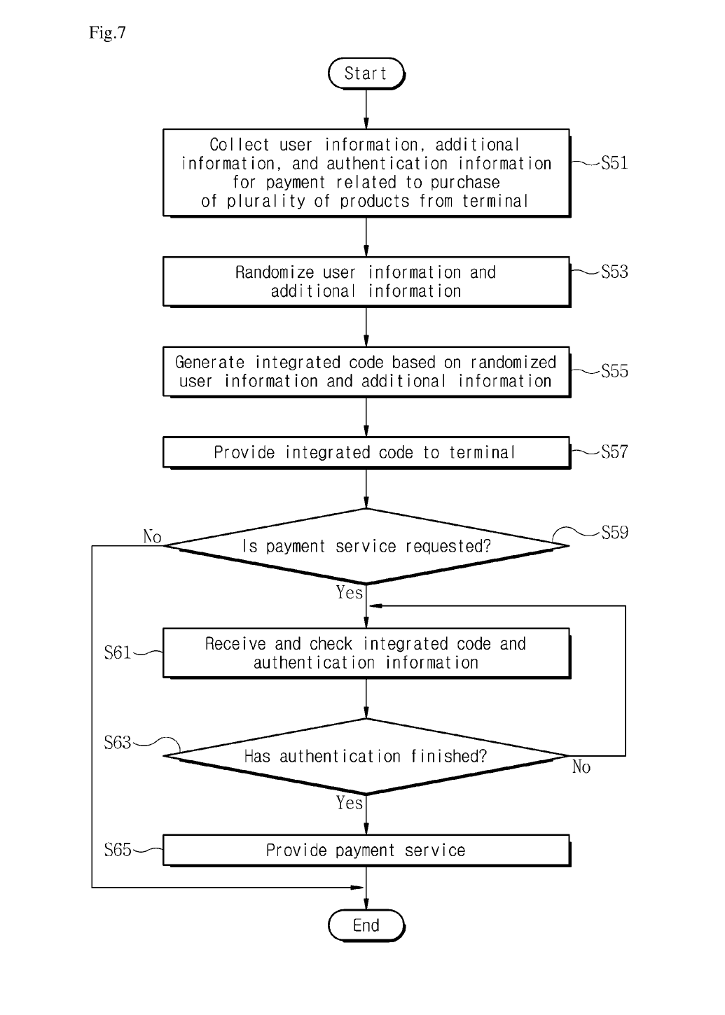

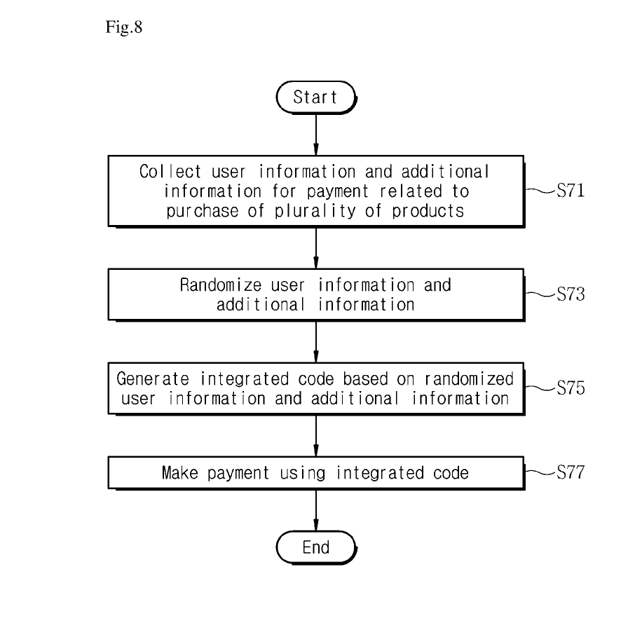

A method for supporting a payment service using an integrated code according to an exemplary embodiment of the present invention will be described below with reference to FIGS. 4 and 5, and a method for supporting a payment service using an integrated code according to another exemplary embodiment of the present invention will be described below with reference to FIGS. 6 and 7. Also, a method for supporting a payment service using an integrated code according to still another exemplary embodiment of the present invention will be described with reference to FIGS. 8 to 10.

FIG. 4 is a flowchart illustrating a method for supporting a payment service using an integrated code in a terminal according to an exemplary embodiment of the present invention.

Referring to FIG. 4, the terminal 10 that provides a payment service using an integrated code in conjunction with the service apparatus 20 according to an exemplary embodiment of the present invention acquires user information and additional information for a payment related to a product purchase and transmits the acquired user information and additional information to the service apparatus 20 (S11 and S13). Here, the user information includes information, such as an ID, a name, a social security number, etc. for directly or indirectly identifying a user, and the additional information includes franchisee information, payment information, and payment means information. Meanwhile, the user information may include any other information that may be a means of personal identification.

In operation S15, the terminal 10 checks whether an integrated code generated on the basis on randomized user information and additional information is received from the service apparatus 20. When the integrated code is received, the terminal 10 makes a payment using the received integrated code in operation S17. At this time, the terminal 10 of the present invention may select information on a payment means, such as a credit card payment, a mobile payment, an account transfer, a cash payment, a debit card payment, a discount card, a point card, etc., and support the payment service by transmitting the selected information on a payment means to the service apparatus 20 so that a payment process using the selected payment means may be performed. At this time, the service apparatus 20 may operate in conjunction with a service providing apparatus which supports provision of a service for the payment means, for example, a credit card server, etc., so that the payment process may be performed. Also, the terminal 10 of the present invention may select a plurality of payment means so that various payment means may be used.

Meanwhile, when no integrated code is received from the service apparatus 20, the terminal 10 may retransmit the user information and additional information to the service apparatus 20 or request the integrated code.

FIG. 5 is a flowchart illustrating a method for supporting a payment service using an integrated code in a service apparatus according to an exemplary embodiment of the present invention.

Referring to FIG. 5, the service apparatus 20 that provides a payment service using an integrated code in conjunction with the terminal 10 according to exemplary embodiments of the present invention collects user information and additional information for a payment related to a purchase of a plurality of products from the terminal 10 in operation S21. Here, the user information includes information, such as an ID, a name, a social security number, etc. for directly or indirectly identifying a user, and the additional information includes franchisee information, payment information, and payment means information. Meanwhile, the user information may include any other information that may be a means of personal identification.

In operation S23, the service apparatus 20 randomizes the collected user information and additional information. At this time, the service apparatus 20 randomizes the additional information by randomly setting the additional information to be a combination of a finite number of characters, numbers, or signs. In other words, the service apparatus 20 generates a random code by combining numbers, characters, or signs randomly extracted from a predefined range. Here, the random code does not have periodicity, and each value is separately determined regardless of an arrangement of previous values.

In operation S25, the service apparatus 20 generates an integrated code based on the randomized user information and additional information. Here, the service apparatus 20 checks a random code corresponding to the user information and a random code corresponding to the additional information and generates the integrated code by sequentially combining the checked random codes.

In operation S27, the service apparatus 20 provides the generated integrated code to the terminal 10. Such an integrated code of the present invention may be used to process a payment service occurring in the terminal 10. After transmitting the generated integrated code to the terminal 10, the service apparatus 20 may receive a payment service request from the terminal 10. Here, the payment service request may include information on a payment means, such as a credit card payment, a mobile payment, an account transfer, a cash payment, a discount card, a point card, and the like.

Then, the service apparatus 20 of the present invention processes a payment service using the information on a payment means and information on the integrated code. Here, the service apparatus 20 may process the payment service in conjunction with an additional service providing apparatus which provides the information on a payment means, for example, an apparatus of a credit card company and the like. Also, when a payment is processed according to the present invention, a terminal may be authenticated using authentication information, and then a payment service may be provided.

Thus far, the method for supporting a payment service using an integrated code according to the exemplary embodiment of the present invention has been described.

A method for supporting a payment service using an integrated code according to another exemplary embodiment of the present invention will be described below. In other words, description will be made focusing on a configuration in which the payment service is provided by sharing an integrated code of the present invention between different terminals.

FIG. 6 is a flowchart illustrating a method for supporting a payment service using an integrated code in a terminal according to another exemplary embodiment of the present invention.

Referring to FIG. 6, in operation S31, the terminal 10 that provides a payment service using an integrated code in conjunction with the service apparatus 20 according to an exemplary embodiment of the present invention acquires user information, additional information, and authentication information for a payment related to a product purchase. Then, in operation S33, the terminal 10 transmits the acquired user information, additional information, and authentication information to the service apparatus 20. Here, the user information includes information, such as an ID, a name, a social security number, and the like for directly or indirectly identifying a user, the additional information includes franchisee information, payment information, and at least one piece of payment means information, and the authentication information includes information on at least one authentication means among a password, fingerprint recognition information, and biometric information applied to a payment service using an integrated code. Meanwhile, the user information may include any other information that may be a means of personal identification.

In operation S35, the terminal 10 determines whether an integrated code generated on the basis of randomized user information and additional information is received from the service apparatus 20. When the integrated code is received, the terminal 10 determines whether to share the integrated code with another terminal in operation S37. On the other hand, when no integrated code is received, the terminal 10 may request retransmission of the integrated code from the service apparatus 20.

When sharing of the integrated code is requested, the terminal 10 provides the integrated code and the authentication information together to the other terminal in operation S39. To this end, the terminal 10 may also share the authentication information with the terminal with which the integrated code is shared, and the authentication information may be transmitted through a text message or other means when the integrated code is transmitted. Subsequently, the other terminal may access the service apparatus 20 and make the payment using the integrated code and the authentication information. On the other hand, when the sharing of the integrated code is not requested, the terminal 10 makes the payment by itself using the integrated code in operation S41.

FIG. 7 is a flowchart illustrating a method for supporting a payment service using an integrated code in a service apparatus according to another exemplary embodiment of the present invention.

Referring to FIG. 7, the service apparatus 20 that provides a payment service using an integrated code in conjunction with the terminal 10 according to exemplary embodiments of the present invention collects user information, additional information, and authentication information for a payment related to a purchase of a plurality of products from the terminal 10 in operation SM. Here, the user information includes information, such as an ID, a name, a social security number, etc. for directly or indirectly identifying a user, the additional information includes franchisee information, payment information, and at least one piece of payment means information, and the authentication information includes information on at least one authentication means among a password, fingerprint recognition information, biometric information, etc. applied to a payment service using an integrated code. Meanwhile, the user information may include any other information that may be a means of personal identification.

In operation S53, the service apparatus 20 randomizes the collected user information and additional information. At this time, the service apparatus 20 randomizes the additional information by randomly setting the additional information to be a combination of a finite number of characters, numbers, or signs. Meanwhile, the service apparatus 20 stores the authentication information collected from the terminal 10, and the stored authentication information is used to perform authentication by being compared with authentication information input from the terminal 10 or another terminal when a payment service using an integrated code is requested

In operation S55, the service apparatus 20 generates an integrated code based on the randomized user information and additional information. Here, the service apparatus 20 checks a random code corresponding to the user information and a random code corresponding to the additional information and generates the integrated code by sequentially combining the checked random codes.

In operation S57, the service apparatus 20 provides the generated integrated code to the terminal 10. This process may be performed in the same way as described above.

Meanwhile, the service apparatus 20 receives information on a payment means, such as a credit card payment, a mobile payment, an account transfer, a cash payment, a discount card, a point card, and the like, from the terminal 10. At this time, the service apparatus 20 may receive information on a plurality of payment means so that various payment means may be used. Then, the service apparatus 20 may combine the received information on a payment means and the previously generated integrated code and process the payment using the integrated code combined with the payment means.

Subsequently, in operation S59, the service apparatus 20 determines whether the payment service is requested. When the payment service is requested, the service apparatus 20 receives an integrated code and authentication information from a terminal which has requested the payment service in operation S61. Then, in operation S63, the service apparatus 20 determines whether authentication has been finished. When the authentication is finished, the service apparatus 20 provides the payment service in operation S65. On the other hand, when the authentication has failed, the service apparatus 20 may request the integrated code and authentication information again.

Thus far, a method for supporting a payment service using an integrated code according to an exemplary embodiment of the present invention has been described.

A method for supporting a payment service using an integrated code according to an exemplary embodiment of the present invention has been described above focusing on a process in which an integrated code is generated by the service apparatus 20. However, the integrated code may be generated by the terminal 10. Such a process will be described with reference to FIGS. 8 to 10.

FIG. 8 is a flowchart illustrating a method for supporting a payment service using an integrated code according to still another exemplary embodiment of the present invention.

Referring to FIG. 8, the terminal 10 for providing a payment service using an integrated code according to still another exemplary embodiment of the present invention collects user information and additional information for a payment related to a purchase of a plurality of products in operation S71. Here, the user information includes information, such as an ID, a name, a social security number, etc. for directly or indirectly identifying a user, and the additional information includes franchisee information, payment information, and payment means information. Meanwhile, the user information may include any other information that may be a means of personal identification.

In operation S73, the terminal 10 randomizes the collected user information and additional information. Here, the terminal 10 randomizes the additional information by randomly setting the additional information to a combination of a finite number of characters, numbers, or signs. In other words, the terminal 10 generates a random code by combining numbers, characters, or signs randomly extracted from a predefined range. Here, the random code does not have periodicity, and each value is separately determined regardless of an arrangement of previous values.

In operation S75, the terminal 10 generates an integrated code based on the randomized user information and additional information. Here, the terminal 10 checks a random code corresponding to the user information and a random code corresponding to the additional information and generates the integrated code by sequentially combining the checked random codes. Subsequently, in operation S77, the terminal 10 makes the payment using the generated integrated code. At this time, the terminal 10 may select information on a payment means, such as a credit card payment, a mobile payment, an account transfer, a cash payment, a debit card payment, a discount card, a point card, and the like, and add the selected information on a payment means to the integrated code. The terminal 10 may select a plurality of payment means so that various payment means may be used.

Meanwhile, according to a method for supporting a payment service using an integrated code according to the still another exemplary embodiment of the present invention, the terminal 10 performs authentication for customer recognition based on terminal information or personal information input by a user and financial information. When an authenticated customer tries to make a payment, the terminal 10 confirms a franchisee by a unique store number being input to a payment app and the like or automatic recognition based on a check for store location information. Subsequently, the user manually inputs an amount of a payment or the terminal 10 automatically inputs a random number received from the service apparatus 20, and then the terminal 10 inputs a previously registered password to perform final authentication.

According to a method for supporting a payment service using an integrated code according to the still another exemplary embodiment of the present invention, a terminal of the present invention may selectively share an integrated code with another terminal.

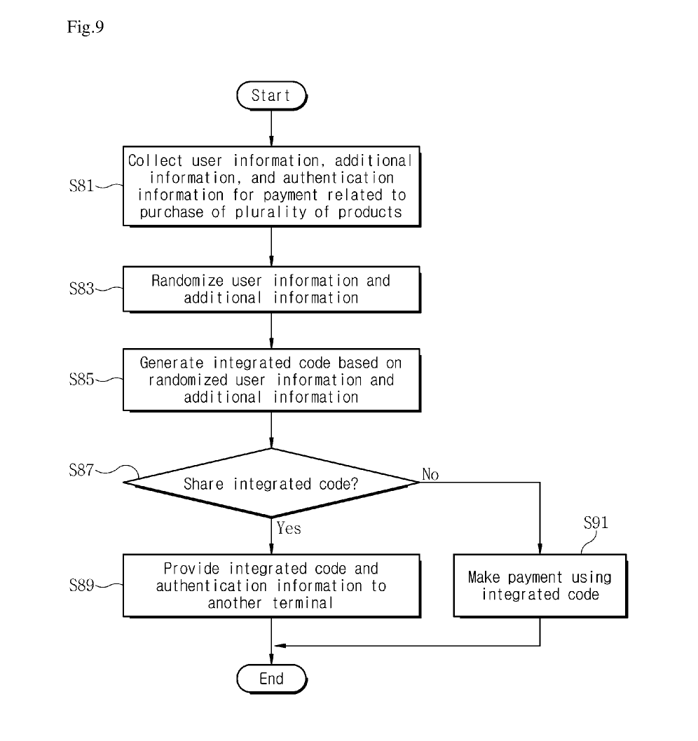

This will be described with reference to FIG. 9.

FIG. 9 is a flowchart illustrating a method for supporting a payment service using an integrated code according to still another exemplary embodiment of the present invention.

Referring to FIG. 9, the terminal 10 for providing a payment service using an integrated code according to still another exemplary embodiment of the present invention collects user information, additional information, and authentication information to make a payment related to a purchase of a plurality of products in operation S81. Then, in operation S83, the terminal 10 randomizes the collected user information and additional information. Here, the terminal 10 randomizes the additional information by randomly setting the additional information to be a combination of a finite number of characters, numbers, or signs.

In operation S85, the terminal 10 generates an integrated code based on the randomized user information and additional information. Here, the terminal 10 checks a random code corresponding to the user information and a random code corresponding to the additional information and generates the integrated code by sequentially combining the checked random codes.

Subsequently, in operation S87, the terminal 10 determines whether to share the integrated code. When sharing of the integrated code is requested, the terminal 10 provides the integrated code and the authentication information to a terminal with which the integrated code is shared in operation S89. To this end, the terminal 10 may also share the authentication information with the terminal with which the integrated code is shared, and the authentication information may be transmitted through a text message or other means when the integrated code is transmitted.

On the other hand, when the sharing of the integrated code is not requested, the terminal 10 accesses the service apparatus 20 and makes the payment by itself using the integrated code in operation S91.

A subsequent process will be described.

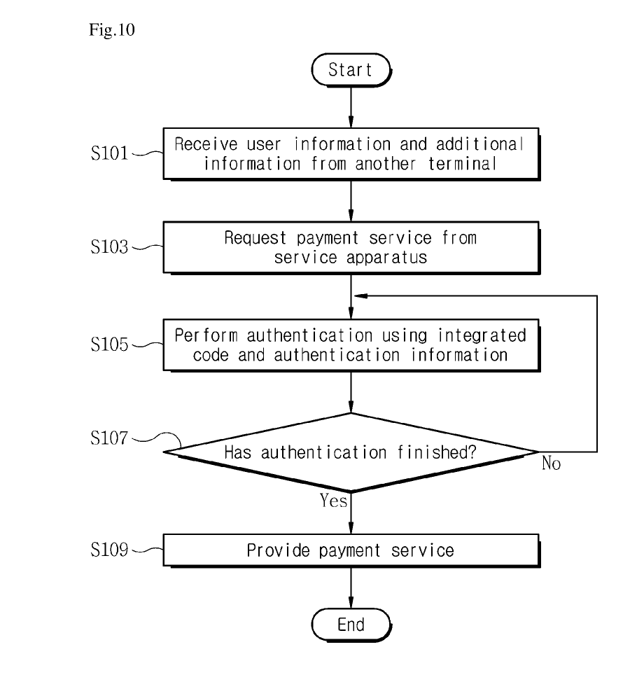

FIG. 10 is a flowchart illustrating an operating method of a terminal receiving an integrated code from another terminal and performing a payment service according to still another exemplary embodiment of the present invention.

Referring to FIG. 10, the terminal 10 for receiving an integrated code from another terminal and providing a payment service according to still another exemplary embodiment of the present invention receives the integrated code and authentication information from the other terminal in operation S101. Then, in operation S103, the terminal 10 requests a payment service using the received integrated code from the service apparatus 20. Subsequently, in operation S105, the service apparatus 20 performs authentication using the integrated code and the authentication information. In other words, it is possible to determine whether authentication information collected from the terminal 10 coincides with the authentication information received from the other terminal.

When the authentication is finished as an authentication result (S107), the service apparatus 20 provides a payment service using the integrated code.

Methods of supporting a payment service using an integrated code according to exemplary embodiments of the present invention have been described above.

Various techniques described herein may be implemented in digital electronic circuitry or in computer hardware, firmware, software, or in a combination thereof. The techniques may be implemented as a computer program product, that is, a computer program tangibly embodied in an information carrier, for example, in a machine-readable storage device (a computer-readable medium) or a radio signal, for execution by or to control operation of a data processing apparatus, for example, a programmable processor, a computer, or a multiple computers. A computer program, such as the computer program(s) described above, may be written in any form of programming language including compiled or interpreted languages, and may be deployed in any form including a stand-alone program or a module, component, subroutine, or other unit suitable for use in a computing environment. The computer program may be deployed to be executed on one computer or multiple computers at one site or distributed across multiple sites and interconnected by a communication network.

Operations of a method may be performed by one or more programmable processors which execute a computer program to perform functions by operating on-input data and generating an output. Operations of a method may also be performed by special purpose logic circuitry, for example, a field programmable gate array (FPGA) or an application-specific integrated circuit (ASIC), and an apparatus may be implemented as the same.

Processors suitable for executing a computer program include, for example, both general and special purpose microprocessors and any one or more processors of any kind of digital computer. In general, a processor will receive instructions and data from a read-only memory (ROM), a random access memory (RAM), or both. Elements of a computer may include at least one processor for executing instructions and one or more memory devices for storing instructions and data. In general, a computer may include one or more mass storage devices for storing data, for example, magnetic, magneto-optical disks, or optical disks, or be coupled thereto to receive data, transfer data, or both. Information carriers suitable for embodying computer program instructions and data include, by way of example, magnetic media, such as a hard disk, a floppy disk, and a magnetic tape, optical media, such as a compact disk ROM (CD-ROM) and a digital video disk (DVD), magneto-optical media, such as a floptical disk, a ROM, a RAM, a flash memory, an erasable programmable ROM (EPROM), an electrically erasable programmable ROM (EEPROM), and on the like. The processor and memory may be supplemented by or incorporated in special purpose logic circuitry.

While this specification contains many specific implementation details, these are not to be construed as limitations on the scope of any inventions or of what may be claimed, but rather as descriptions of features specific to particular implementations of particular inventions. Certain features of the invention that are described in the context of separate embodiments may also be implemented in combination in a single embodiment. Conversely, various features that are described in the context of a single embodiment may also be implemented separately or in any suitable sub-combination in a plurality of embodiments. Although features may be described above as acting in certain combinations and even initially claimed as such, one or more features from the claimed combination may be omitted from the combination in some cases, and the claimed combination may be directed to a sub-combination or variation of a sub-combination.

Similarly, while operations are illustrated in the drawings in a particular order, this is not to be understood as requiring that such operations be performed in the particular order illustrated or in sequential order, or that all illustrated operations be performed, to achieve desirable results. In particular cases, multitasking and parallel processing may be advantageous. Also, the separation of various system components in the embodiments described above are not to be understood as requiring such separation in all embodiments, and it should be understood that the described program components and systems may generally be integrated together in a single software product or packaged into multiple software products.

Exemplary embodiments disclosed in the present specification and the drawings merely propose particular examples and are not intended to limit the scope of the present invention. Those of ordinary skill in the art should appreciate that, besides the exemplary embodiments disclosed herein, various modifications and variations may be made based on the technical spirit of the present invention.

### INDUSTRIAL APPLICABILITY

According to the present invention, an integrated code is generated by randomizing user information and additional information to purchase a plurality of products, and a payment is made by using the integrated code. Accordingly, when a customer purchases a plurality of products at a particular store, the present invention is convenient because it is possible to simultaneously perform payments for the respective products using the integrated code. Also, since the user information and the additional information are randomized and provided, security can be improved. Since a payment for a product purchased offline can be made online, payment compatibility is high. Also, a one-click payment service using an integrated code for a plurality of products is possible. Also, since a user performs personal authentication through a portable terminal, there is no worry about non-authentication. Also, the customer can easily and conveniently make an integrated payment for several products by inputting only a payment amount and numbers or characters of a randomized code and the like. Also, it is possible to avoid difficulties in recognizing a barcode, a QR code, and the like. There is enough possibility of commercialization or business, and the present invention can be clearly implemented in practice. Consequently, the present invention has industrial applicability.

1. A service apparatus comprising:
a service communication unit configured to communicate with a plurality of terminals and transmit and receive data for providing a payment service based on an integrated code; and
a service control unit configured to collect user information and additional information for processing a payment related to a product purchase from any one terminal, randomize the collected user information and additional information, generate an integrated code based on the randomized user information and additional information, and provide the generated integrated code to the terminal.

2. The service apparatus of claim 1, wherein the user information includes at least one of an identity (ID), a name, and a social security number for identifying a user.

3. The service apparatus of claim 1, wherein the additional information includes franchisee information, payment information, and at least one piece of payment means information.

4. The service apparatus of claim 1, wherein the service control unit randomizes the additional information by randomly setting the additional information to be a combination of characters, numbers, or signs.

5. The service apparatus of claim 1, wherein the service control unit checks a random code corresponding to the user information and a random code corresponding to the additional information and generates the integrated code by combining the checked random codes.

6. The service apparatus of claim 1, wherein the service control unit additionally collects authentication information from the terminal together with the user information and the additional information.

7. The service apparatus of claim 6, wherein the authentication information includes information on at least one authentication means among a password, fingerprint recognition information, and biometric information.

8. The service apparatus of claim 6, wherein, when an integrated code identical to the integrated code provided to the terminal and authentication information are received from any other terminal, the service control unit performs control so that authentication is performed by comparing the authentication information received from the terminal and the authentication information received from the other terminal and then the payment service is provided according to a request of the other terminal.

9. A terminal comprising:
a communication unit configured to communicate with a service apparatus and transmit and receive data for making a payment related to a product purchase based on an integrated code; and
a control unit configured to acquire user information and additional information for the payment related to the product purchase, transmit the acquired user information and additional information to the service apparatus, receive an integrated code generated based on randomized user information and additional information from the service apparatus, and perform control so that the payment is made using the received integrated code.

10. The terminal of claim 9, wherein the control unit selects information on at least one payment means among a credit card payment, a mobile payment, an account transfer, a cash payment, a debit card payment, a discount card, and a point card, and performs control so that the selected information on a payment means is included in the additional information or transmitted to the service apparatus after the integrated code is received.

11. The terminal of claim 9, wherein, after the user information and the additional information for the payment related to the product purchase are collected, the control unit randomizes the collected user information and additional information, generates the integrated code based on the randomized user information and additional information, and performs control so that the payment is made using the generated integrated code.

12. The terminal of claim 9, wherein the controller additionally collects authentication information together with the user information and the additional information for the payment related to the product purchase, and shares the generated integrated code with at least one other terminal.

13. The terminal of claim 12, wherein, when an integrated code and authentication information are received from the other terminal and the authentication information received from the other terminal and the collected authentication information match, the control unit finishes authentication and then performs control by requesting a payment service using the received integrated code from the service apparatus so that the payment is made.

14. A method for supporting a payment service using an integrated code, the method comprising:
collecting, by a service apparatus, user information and additional information for a payment related to a product purchase from any one terminal;
randomizing, by the service apparatus, the collected user information and additional information;
generating, by the service apparatus, an integrated code based on the randomized user information and additional information; and
providing, by the service apparatus, the generated integrated code to the terminal.

15. The method of claim 14, further comprising, after the providing of the generated integrated code to the terminal:
receiving, by the service apparatus, information on at least one payment means among a credit card payment, a mobile payment, an account transfer, a cash payment, a discount card, and a point card;
combining, by the service apparatus, the received information on a payment means and the previously generated integrated code; and
processing, by the service apparatus, the payment using the integrated code combined with the payment means.

16. The method of claim 14, wherein the collecting of the user information and the additional information includes additionally collecting, by the service apparatus, authentication information from the terminal, and
the method further includes, after the providing of the generated integrated code to the terminal:
receiving, by the service apparatus, an integrated code identical to the integrated code provided to the terminal and authentication information from another terminal;
comparing, by the service apparatus, the authentication information received from the terminal and the authentication information received from the other terminal to perform authentication; and
processing, by the service apparatus, the payment according to a request of the other terminal when the authentication succeeds.
